(19) United States
(12) Patent Application Publication
(10) Pub. No.: US 2018/0077298 A1
(43) Pub. Date: Mar. 15, 2018

(54) IMAGE-CAPTURING ASSISTANCE DEVICE AND IMAGE-CAPTURING DEVICE

(71) Applicant: OLYMPUS CORPORATION, Tokyo (JP)

(72) Inventor: Maki MATSUNAGA, Tokyo (JP)

(73) Assignee: OLYMPUS CORPORATION, Tokyo (JP)

(21) Appl. No.: 15/822,848

(22) Filed: Nov. 27, 2017

Related U.S. Application Data
(63) Continuation of application No. PCT/JP2016/064967, filed on May 20, 2016.

(30) Foreign Application Priority Data
Jun. 1, 2015 (JP) 2015-111174

(51) Int. Cl. H04N 1/00; G06T 5/00

(52) U.S. Cl. CPC H04N 1/00167; G06T 5/00

(57) ABSTRACT

Provided is an image-capturing assistance device that includes: a target-conditions obtaining unit that obtains target conditions; an image-capturing-conditions obtaining unit that obtains image-capturing conditions of a subject on an image-capturing unit; an assistance-information storage unit that stores assistance information in association with the image-capturing conditions for specific editing conditions that depend on the image-capturing conditions among editing conditions obtained by the target-conditions obtaining unit; an assistance-information obtaining unit that reads out the assistance information corresponding to the specific editing conditions from the assistance-information storage unit on the basis of the image-capturing conditions; and a display unit that presents the assistance information obtained by the assistance-information obtaining unit.

### CROSS-REFERENCE TO RELATED APPLICATIONS

This is a continuation of International Application PCT/JP2016/064967 which is hereby incorporated by reference herein in its entirety.

This application is based on Japanese Patent Application No. 2015-111174, the contents of which are incorporated herein by reference.

### TECHNICAL FIELD

The present invention relates to an image-capturing assistance device and an image-capturing device.

### BACKGROUND ART

In the related art, there are known cameras that store photographing conditions as header information together with the photographed images, and when a user selects any of the stored images when taking a photograph, the photographing conditions, which are included in the header information stored together with the selected image, are set (for example, refer to PTL 1).

In addition, there are known cameras that compare photographing condition information appended to images photographed in the past and current photographing situation information, and that correct the photographing condition information in accordance with the photographing situation information (for example, refer to PTL 2).

### CITATION LIST

### Patent Literature

PTL 1: Japanese Unexamined Patent Application Publication No. 8-88790

PTL 2: Japanese Unexamined Patent Application Publication No. 2013-77876

### SUMMARY OF INVENTION

### Technical Problem

However, it is sometimes not possible to obtain the same photography result with the cameras disclosed in PTL 1 and PTL 2 even when a photograph is newly taken using photographing conditions that are the same as those of an image obtained in the past or using photographing conditions that have been corrected in accordance with the current photographing situation information.

For example, in the case where the distance between the camera and the subject, the zoom magnification, the camera orientation, the attached lens, the attached flash, or the like is different, there is an issue that it is difficult to reproduce the image obtained in the past as long as the photographing conditions are not made the same.

The present invention has been made in light of the above-described circumstances, and it is an object thereof to provide an image-capturing assistance device and an image-capturing device that can reproduce an image obtained in the past without requiring that the photographing conditions be made the same.

In order to achieve the above-described object, the present invention provides the following solutions.

One aspect of the present invention provides an image-capturing assistance device that includes: a target-conditions obtaining unit that obtains target conditions; an image-capturing-conditions obtaining unit that obtains image-capturing conditions of a subject on an image-capturing unit; an assistance-information storage unit that stores assistance information in association with the image-capturing conditions for specific editing conditions that depend on the image-capturing conditions among editing conditions obtained by the target-conditions obtaining unit; an assistance-information obtaining unit that reads out the assistance information corresponding to the specific editing conditions from the assistance-information storage unit on the basis of the image-capturing conditions; and a display unit that presents the assistance information obtained by the assistance-information obtaining unit.

### Advantageous Effects of Invention

The present invention affords the advantage that an image that was obtained in the past can be reproduced without requiring that the image-capturing conditions be made the same.

### BRIEF DESCRIPTION OF DRAWINGS

FIG. 1 is a block diagram illustrating an image-capturing device according to an embodiment of the present invention.

FIG. 2 is a block diagram illustrating in detail an image-processing unit of the image-capturing device in FIG. 1.

FIG. 3 illustrates an example of storage content in an image-capturing-scene storage unit included in the image-capturing device in FIG. 1.

FIG. 4 illustrates an example of storage content in a first-editing-conditions storage unit included in the image-capturing device in FIG. 1.

FIG. 5 is a block diagram that illustrates in detail an image-capturing assistance device according to an embodiment of the present invention included in the image-capturing device in FIG. 1.

FIG. 6 illustrates an example of storage content in a second-editing-conditions storage unit included in the image-capturing assistance device in FIG. 5.

FIG. 7 illustrates an example of storage content in an assistance-information storage unit included in the image-capturing assistance device in FIG. 5.

FIG. 8 is a flowchart that describes the operation of the image-capturing device in FIG. 1.

FIG. 9 is a block diagram that illustrates a modification of the image-capturing assistance device in FIG. 5.

### DESCRIPTION OF EMBODIMENTS

Hereafter, an image-capturing device 1 according to an embodiment of the present invention will be described while referring to the drawings.

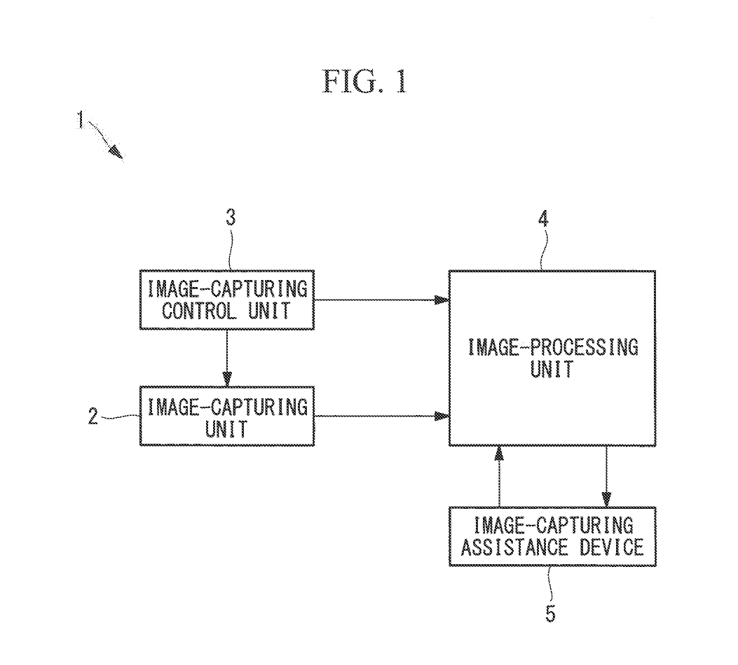

The image-capturing device 1 according to this embodiment is a digital camera. As illustrated in FIG. 1, the image-capturing device 1 includes: an image-capturing unit 2; an image-capturing control unit 3 that controls the image-capturing unit 2; an image-processing unit 4 that edits an image obtained by the image-capturing unit 2 and stores the edited image; and an image-capturing assistance device 5 according to an embodiment of the present invention.

The image-capturing unit 2 includes a lens, a shutter, an image sensor such as a CCD, and so forth, which are not illustrated, and can obtain a live view image or a provisionally photographed image in a state where a shutter has been half pressed.

The image-capturing control unit 3 automatically sets or allows manual setting of first image-capturing conditions, such as an F number, which is determined by the attached lens, a shutter speed or ISO sensitivity, which is determined by the effect of external light and so forth, and a focal length, which is determined by the position of the subject, and so forth.

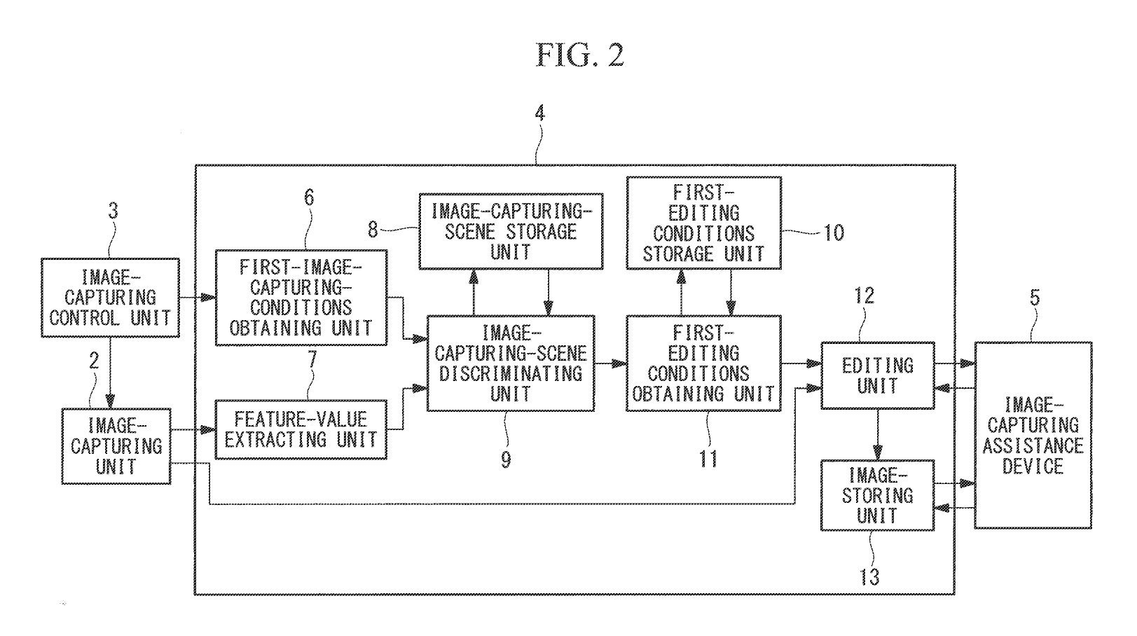

As illustrated in FIG. 2, the image-processing unit 4 includes a first-image-capturing-conditions obtaining unit 6 that obtains the first image-capturing conditions set by the image-capturing control unit 3, and a feature-value extracting unit 7 that extracts a feature value from image data obtained by the image-capturing unit 2. As the method of extracting the feature value from the image, any of various methods typically performed as object recognition methods can be used. For example, an LBP, SIFT, SURF, ORB, or HSV histogram is extracted. Subject classification is determined by machine learning such as SVM using one of these methods.

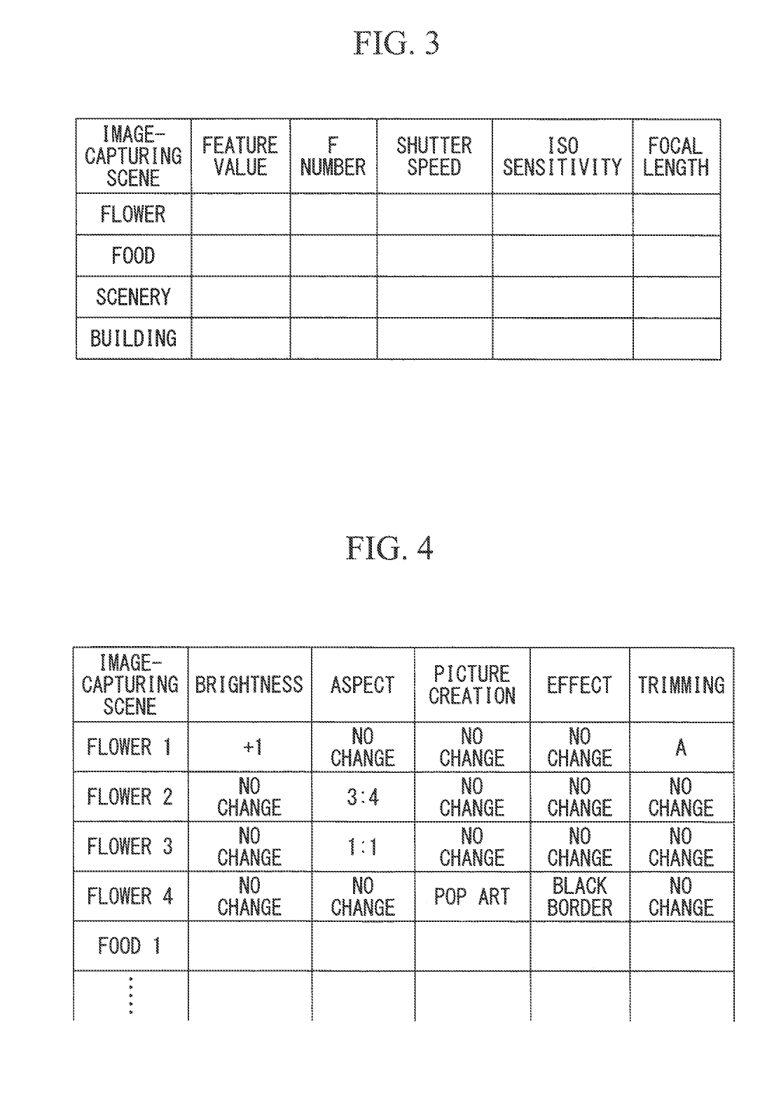

Furthermore, as illustrated in FIG. 2, the image-processing unit 4 includes an image-capturing-scene storage unit 8 that stores a feature value and first image-capturing conditions in association with each other for each image-capturing scene. Subjects can be exemplified as image-capturing scenes, and as illustrated in FIG. 3, the image-capturing scenes can be set as “flower”, “food”, “scenery”, or “building”.

In addition, the image-processing unit 4 includes an image-capturing-scene discriminating unit 9 that searches inside the image-capturing-scene storage unit 8, and discriminates an image-capturing scene by using the first image-capturing conditions obtained by the first-image-capturing-conditions obtaining unit 6 and the feature value of the image extracted by the feature-value extracting unit 7 as keys.

In addition, the image-processing unit 4 includes a first-editing-conditions storage unit 10 that stores first editing conditions in association with the image-capturing scenes, and a first-editing-conditions obtaining unit 11 that obtains first editing conditions from the first-editing-conditions storage unit 10 on the basis of the image-capturing scene discriminated by the image-capturing-scene discriminating unit 9. For example, the first-editing-conditions storage unit 10 stores data in which a plurality of different first editing conditions are associated with an image-capturing scene, for example, “flower”, as partially illustrated in FIG. 4. “Brightness”, “aspect”, “picture creation”, “effect”, and “trimming” can be given as examples of the first editing conditions.

The first-editing-conditions obtaining unit 11 obtains by reading out from the first-editing-conditions storage unit 10 a preset number of first editing conditions associated with an image-capturing scene that has been searched for inside the image-capturing-scene storage unit 8 on the basis of the first image-capturing conditions and the feature value. For example, in the case where the image-capturing scene is discriminated as “flower”, a preset number of first editing conditions associated with the image-capturing scene “flower” such as “flower 1”, “flower 2”, . . . and so on inside the first-editing-conditions storage unit 10 are read out.

The image-processing unit 4 includes a editing unit 12 that edits an image obtained by the image-capturing unit 2 using the read-out preset number of first editing conditions, and an image-storing unit 13 that stores the preset number of images generated by the editing performed by the editing unit 12 in association with the respective first editing conditions of the images. The first editing conditions are associated with the respective images by using information such as “flower 1”, “flower 2” . . . and so on serving as identification information indicating the respective first editing conditions as image header information.

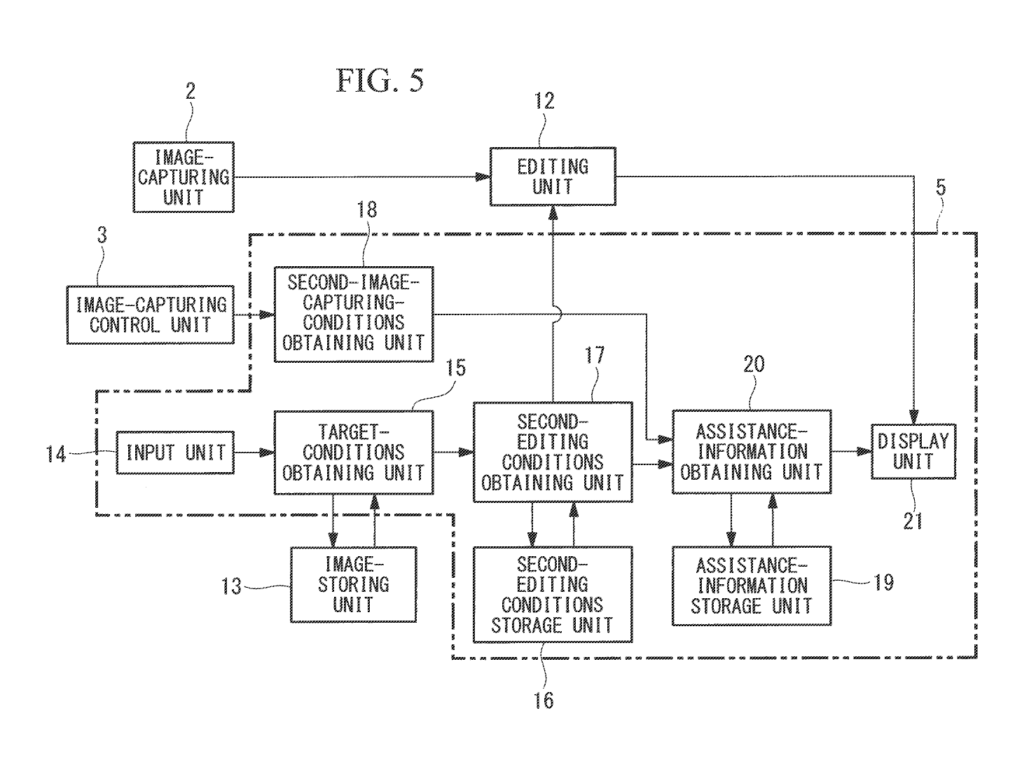

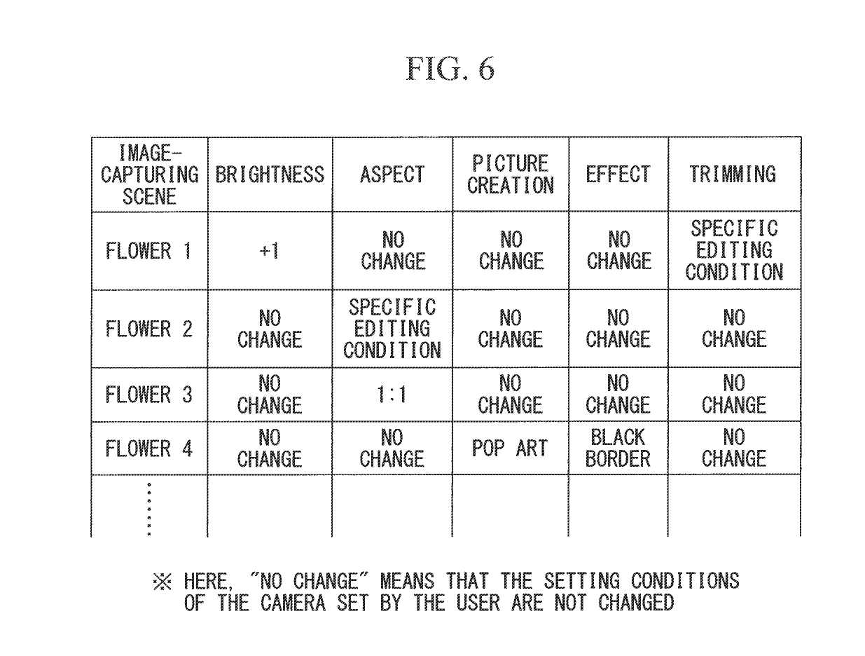

As indicated by the broken line in FIG. 5, the image-capturing assistance device 5 according to this embodiment includes: an input unit 14 with which a user performs input in order to specify a target image; a target-conditions obtaining unit 15 that obtains first editing conditions of the target image from inside the image-storing unit 13 in accordance with an input from the input unit 14; a second-editing-conditions storage unit 16 that stores second editing conditions in association with image-capturing scenes that serve as identification information of the first editing conditions, as illustrated in FIG. 6; and a second-editing-conditions obtaining unit 17 that reads out the second editing conditions from inside the second-editing-conditions storage unit 16 using the identification information of the first editing conditions of the target image obtained by the target-conditions obtaining unit 15.

In addition, the image-capturing assistance device 5 includes a second-image-capturing-conditions obtaining unit (image-capturing-conditions obtaining unit) 18 that obtains, from the image-capturing control unit 3, second image-capturing conditions such as the F number of the image-capturing unit 2 attached to the image-capturing device 1, the shutter speed, the ISO sensitivity, and the focal length, when the user uses the input unit 14 to select a target image that will serve as a target the next time a photograph is taken.

Furthermore, the image-capturing assistance device 5 according to this embodiment includes: an assistance-information storage unit 19 that stores assistance information in association with identification information of the second editing conditions; an assistance-information obtaining unit 20 that obtains assistance information from inside the assistance-information storage unit 19 using the identification information of the second editing conditions obtained by the second-editing-conditions obtaining unit 17; and a display unit 21 that displays the obtained assistance information.

In addition, the second editing conditions obtained by the second-editing-conditions obtaining unit 17 are sent to the editing unit 12 of the image-processing unit 4, an image obtained by the image-capturing unit 2 is edited by the editing unit 12 using the second editing conditions, and the edited image is displayed on the display unit 21. The display unit 21 is a liquid crystal display included in the digital camera.

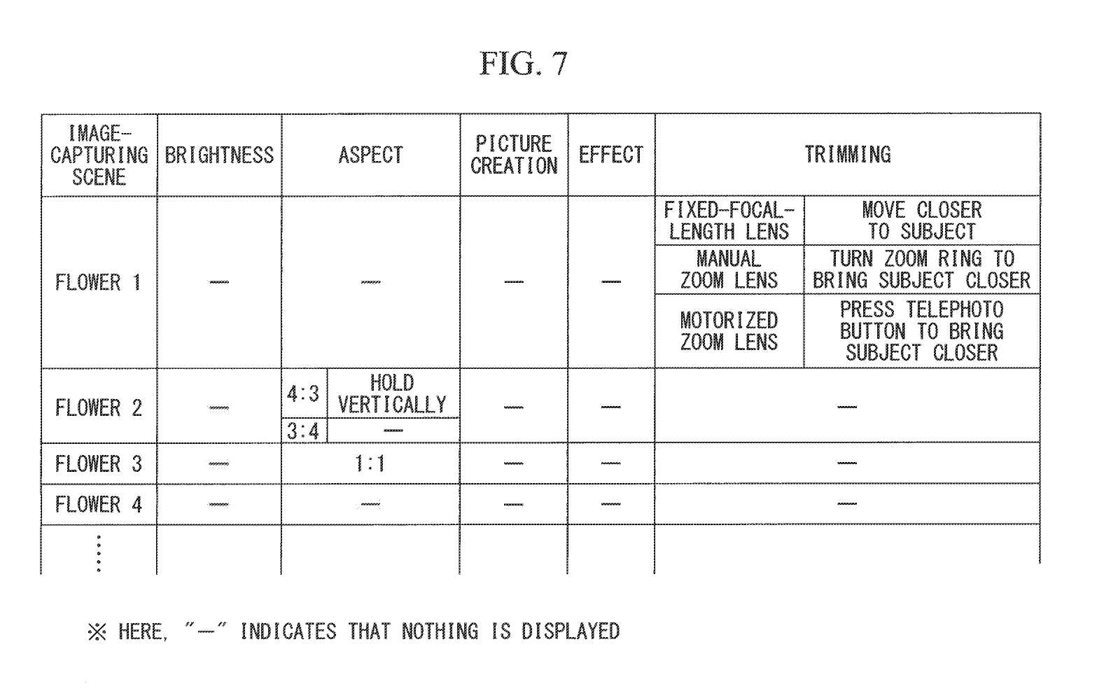

As illustrated in FIG. 7, the assistance information is set in accordance with the second image-capturing conditions for specific editing conditions that depend on the second image-capturing conditions among the second editing conditions obtained by the second-editing-conditions obtaining unit 17. In the example illustrated in FIG. 7, trimming information that is set in “flower 1” among the second editing conditions in FIG. 6, and an aspect condition that is set in “flower 2” are specific editing conditions and are stored as assistance information in the assistance-information storage unit 19.

In other words, for an image edited using the first editing conditions “flower 1” illustrated in FIG. 4, the trimming information is set to “A”, some kind of trimming is performed, and as a result, the image becomes an image in which the subject is enlarged. In contrast, the trimming information in the second editing conditions “flower 1” illustrated in FIG. 6 is a specific editing condition, and therefore, assistance information is obtained from inside the assistance-information storage unit 19 in accordance with the second image-capturing conditions. In the case where an obtained second image-capturing condition indicates that a fixed-focal-length lens is attached to the image-capturing unit 2, assistance information “move closer to the subject” is obtained.

Furthermore, in the case where the obtained second image-capturing condition indicates that a manual zoom lens is attached to the image-capturing unit 2, assistance information “turn the zoom ring to bring the subject closer” is obtained. In addition, in the case where the obtained second image-capturing condition indicates that a motorized zoom lens is attached to the image-capturing unit 2, assistance information “press telephoto button to bring subject closer” is obtained.

Furthermore, for an image edited using the first editing conditions “flower 2” illustrated in FIG. 4, the aspect information is set to 3:4, and the image becomes an image in which the aspect is changed to 3:4. In contrast, the aspect information in the second editing conditions “flower 2” illustrated in FIG. 6 is a specific editing condition, and therefore, assistance information is obtained from inside the assistance-information storage unit 19 in accordance with the second image-capturing conditions. In the case where an obtained second image-capturing condition indicates that the orientation of the image-capturing unit 2 is 4:3 (the image-capturing unit 2 is held horizontally), assistance information “hold vertically” is obtained, as illustrated in FIG. 7.

On the other hand, in the case where the second image-capturing condition is 3:4 (image-capturing unit 2 held vertically), no assistance information is obtained.

The obtained assistance information is displayed on the display unit 21.

In addition, the conditions except for a specific editing condition among the obtained second editing conditions (common editing conditions) are sent to the editing unit 12, the image obtained by the image-capturing unit 2 is edited using the common editing conditions, and the edited image is displayed on the display unit 21.

Hereafter, the operation of the thus-configured image-capturing assistance device 5 and image-capturing device 1 according to this embodiment will be described.

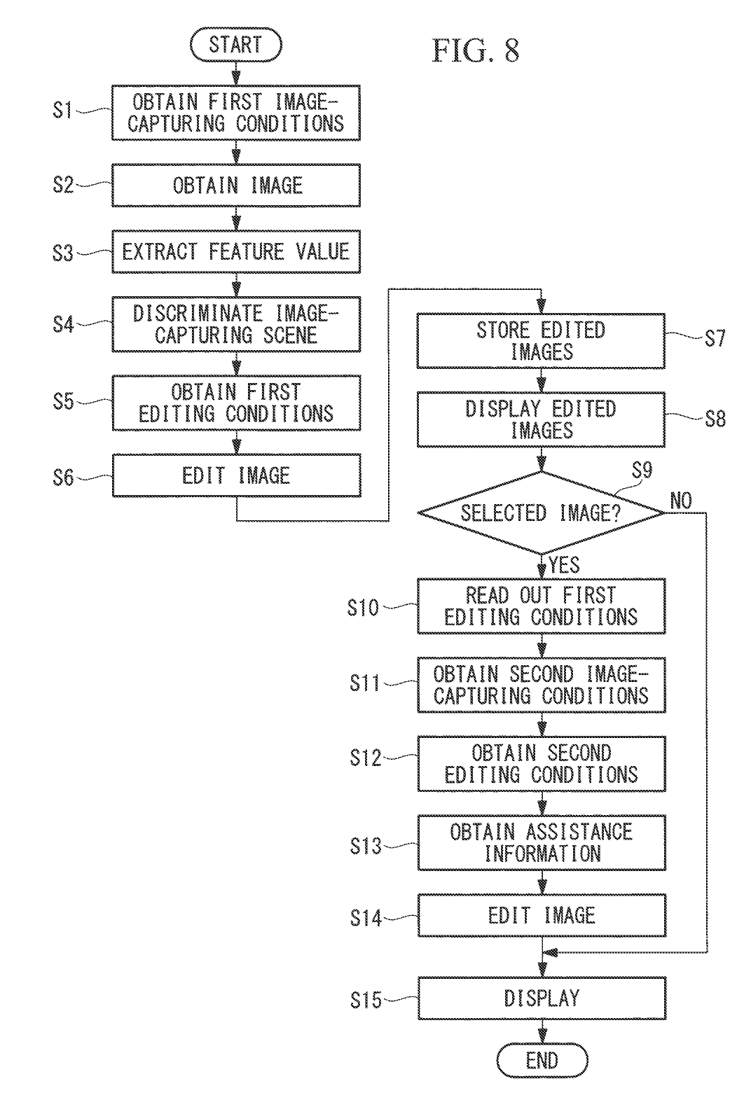

In the case where an image is to be obtained using the image-capturing device 1 according to this embodiment, when various image-capturing conditions such as the lens, the flash and so on are set and the image-capturing unit 2 is made to operate, as illustrated in FIG. 8, first image-capturing conditions are obtained from the image-capturing control unit 3 by the first-image-capturing-conditions obtaining unit 6 (step S1), and an image of a subject is obtained by the image-capturing unit 2 (step S2).

Once the image is obtained, the image is sent to the feature-value extracting unit 7 from the image-capturing unit 2, and a feature value is extracted (step S3). The extracted feature value and the first image-capturing conditions obtained in step S1 are sent to the image-capturing-scene discriminating unit 9, and a corresponding image-capturing scene is read out from the image-capturing-scene storage unit 8 (step S4).

The discriminated image-capturing scene is sent to the first-editing-conditions obtaining unit 11, and a preset number of corresponding first editing conditions are read out from inside the first-editing-conditions storage unit 10 (step S5). As an example, in the case where six images are to be generated, the “preset number” is 6. In the case where 100 editing conditions for use when a flower is photographed have been prepared in advance, the preset number of editing patterns are read each time a photograph is taken such that flower editing conditions 1 to 6 are read for the first frame, flower editing conditions 7 to 13 are read for the second frame, and so on. In addition, different numbers of editing conditions may be prepared depending on the photographing scene such that 100 editing conditions are prepared for flowers and 200 editing conditions are prepared for the case where food is photographed. The obtained first editing conditions are sent to the editing unit 12, editing is performed on the image obtained by the image-capturing unit 2, and edited images are thereby generated (step S6). The generated edited images are stored in the image-storing unit 13 together with the first editing conditions (step S7).

The thus-generated edited images are displayed on the display unit 21 (step S8).

The edited images are displayed on the display unit 21 such that the image obtained by the image-capturing unit 2 (original image) and the individual edited images can be compared with each other.

For example, the original image is displayed first, and then the display is switched to the first edited image by tapping the screen. The subsequent edited images are sequentially displayed by tapping the screen. Another method in which the original image and one or more edited images are simultaneously displayed on the display unit 21 may instead be employed as the display method.

In this state, the user decides upon a target image that is to be the target of the next image capturing operation. The target image is decided upon by selecting any of the images displayed on the display unit 21 (step S9). The image may be selected by selecting an icon that is associated with the image and is displayed on the display unit 21, or may be selected by moving a cursor.

Once the target image is selected, the first editing conditions stored in association with the selected target image are read out from the image-storing unit 13 (step S10). In addition, second image-capturing conditions are obtained from the image-capturing control unit 3 by the second-image-capturing-conditions obtaining unit 18 (step S11). The read out first editing conditions are sent to the second-editing-conditions obtaining unit 17, and the corresponding second editing conditions are read out from the second-editing-conditions storage unit 16 (step S12).

In addition, the second image-capturing conditions obtained by the second-image-capturing-conditions obtaining unit 18 and the second editing conditions obtained by the second-editing-conditions obtaining unit 17 are sent to the assistance-information obtaining unit 20, and corresponding assistance information is obtained from the assistance-information storage unit 19 (step S13).

On the other hand, the second editing conditions obtained by the second-editing-conditions obtaining unit 17 are sent to the editing unit 12, and the image obtained by the image-capturing unit 2 is edited by the editing unit 12 (step S14).

The edited images and the assistance information are sent to the display unit 21 and are displayed on the display unit 21 (step S15).

Thus, with the image-capturing assistance device 5 and the image-capturing device 1 according to this embodiment, assistance information corresponding to the second image-capturing conditions is provided for editing conditions that depend on the second image-capturing conditions, and therefore, there is an advantage in that an image obtained in the past can be reproduced even if the image-capturing conditions cannot be made the same.

In other words, in the case where an image obtained by first image capturing has been trimmed, even if a fixed-focal-length lens is attached when second image capturing is performed, an image in which the subject has been enlarged similarly to when trimming is performed can be obtained without part of the obtained image being removed by trimming by having the user move closer to the subject. Alternatively, the same effect can be obtained by zooming in in the case where a zoom lens is attached. In this case, since the whole of the image obtained using an image sensor is used, an image that is close to a target image can be obtained without causing a reduction in resolution.

Furthermore, there is an advantage in that, in the case where an image was captured while holding the image-capturing unit 2 in a vertical orientation at the time of first image capturing, an image that is close to the target image can be obtained without causing a reduction in resolution by performing image capturing using a wider angle of view if the user changes the way in which they are holding the image-capturing unit 2 to a vertical orientation in accordance with assistance information when the user is holding the image-capturing unit 2 in a horizontal orientation at the time of second image capturing.

In addition, although it has been assumed in this embodiment that assistance information corresponding to image-capturing conditions is provided in which trimming and aspect are specific editing conditions, other editing conditions may be employed as specific editing conditions in addition to or instead of these specific editing conditions. For example, in the case where an external flash was attached at the time of first image capturing but is not attached at the time of second image capturing, assistance information “attach an external flash” may be displayed. In the case where there is a difference between the situation at the time of first image capturing and the situation at the time of second image capturing in terms of the presence/absence or the type of an accessory such as a flash or a lens as in this example, the user may be informed of this fact by displaying assistance information.

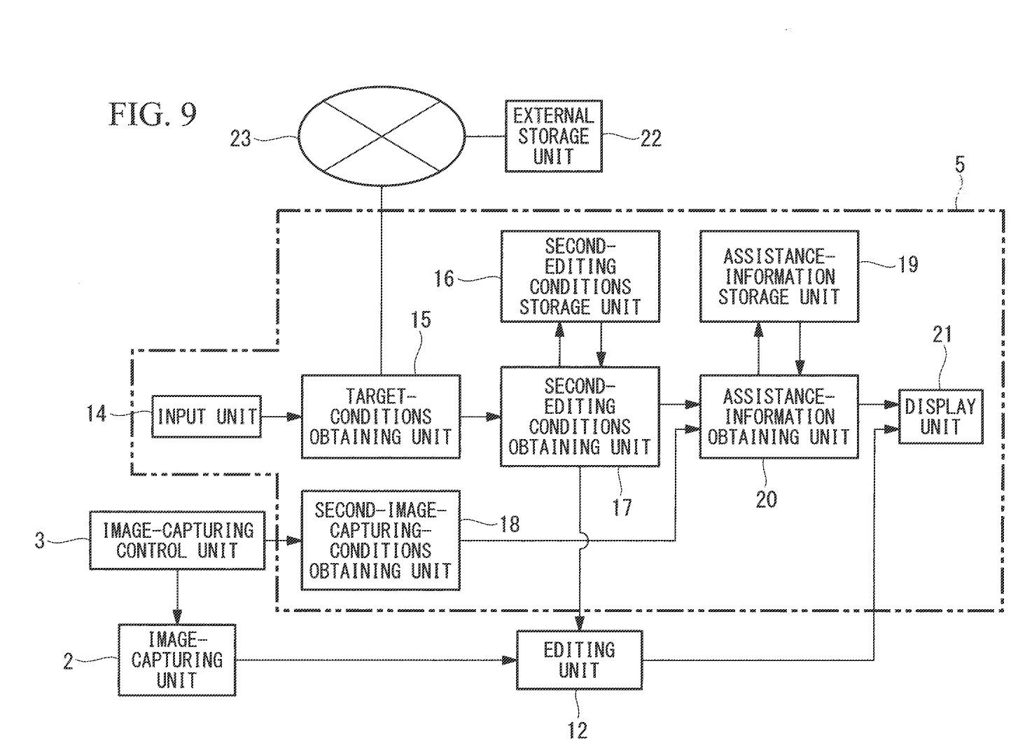

Furthermore, although an example is described in this embodiment in which a plurality of past images are obtained as target images and stored in the image-storing unit 13 in association with editing conditions in the image-capturing device 1, the target images may instead be obtained from the outside, as illustrated in FIG. 9.

In other words, the target-conditions obtaining unit 15 of the image-capturing assistance device 5 reads from a server, which is an external storage unit 22, via a network 23 candidate images, which are candidate target images, from the external storage unit 22, the user selects any one of the images, and thereby the first editing conditions stored in the header of the image are read out. The processing subsequent to this is the same as in the above-described embodiment.

With this configuration, there is an advantage in that not only an image that was captured and stored by the user but also an image obtained from the outside via network communication means such as the Internet can be used as a target image, and an image that approximates the target image can be reproduced from first editing information that is stored together with the image. In this case, even when first image-capturing conditions at the time when the target image was obtained and second image-capturing conditions at the time when an image is later obtained differ from each other, an image that approximates the target image can be obtained even in a situation where the first image-capturing conditions cannot be reproduced by displaying assistance information obtained by the assistance-information obtaining unit 20 on the display unit 21 and having the user operate the device in accordance with the assistance information.

In addition, although a server connected via the network 23 has been exemplified as the external storage unit 22, a removable memory device may be employed instead. Furthermore, a memory device that exchanges data via wireless means or short-range communication means that communicates without the network 23 may be employed instead.

In addition, an ideal-conditions storage unit, which is not illustrated, may be provided in addition to the assistance-information storage unit 19. Although settings that are needed when taking a photograph such as the combination of shutter speed and aperture, and white balance are automatically set by the digital camera, assistance information may be displayed so as to enable a more impressive image to be obtained for each image-capturing scene by using ideal conditions corresponding to an image-capturing scene discrimination result.

For example, in the case where the image-capturing scene discrimination result is “flower”, a better photograph can be obtained when the range in which focus is realized is made narrow by making the aperture value as small as possible. Therefore, a condition for making the aperture value small, such as a value from F1.6 to F3.2, is stored in the ideal-conditions storage unit as an ideal condition of the aperture value for “flower”.

Although the aperture value from the second image-capturing conditions can be set to a smaller value using the attached lens, in the case where it is determined that the user has not set the aperture value, assistance information “set aperture value to as small a value as possible” should be displayed.

In addition, an adjustment bar for adjusting the aperture value may be displayed on the display unit 21 together with display of the assistance information.

The image image-capturing assistance device, the image image-capturing device, the image image-capturing system and the like according to the present embodiment may include a processor and a storage (e.g., a memory). The functions of individual units in the processor may be implemented by respective pieces of hardware or may be implemented by an integrated piece of hardware, for example. The processor may include hardware, and the hardware may include at least one of a circuit for processing digital signals and a circuit for processing analog signals, for example. The processor may include one or a plurality of circuit devices (e.g., an IC) or one or a plurality of circuit elements (e.g., a resistor, a capacitor) on a circuit board, for example. The processor may be a CPU (Central Processing Unit), for example, but this should not be construed in a limiting sense, and various types of processors including a GPU (Graphics Processing Unit) and a DSP (Digital Signal Processor) may be used. The processor may be a hardware circuit with an ASIC. The processor may include an amplification circuit, a filter circuit, or the like for processing analog signals. The memory may be a semiconductor memory such as an SRAM and a DRAM; a register; a magnetic storage device such as a hard disk device; and an optical storage device such as an optical disk device. The memory stores computer-readable instructions, for example. When the instructions are executed by the processor, the functions of each unit of the image processing device and the like are implemented. The instructions may be a set of instructions constituting a program or an instruction for causing an operation on the hardware circuit of the processor.

The units in the image-capturing assistance device, the image-capturing device, the image-capturing system and the like according to the present embodiment may be connected with each other via any types of digital data communication such as a communication network or via communication media. The communication network may include a LAN (Local Area Network), a WAN (Wide Area Network), and computers and networks which form the internet, for example.

The image-capturing assistance device according to the present embodiment may be a mobile terminal such as a smartphone. The image-capturing unit according to the present embodiment may be a digital camera. The image-capturing system according to the present embodiment may be configured by connecting a mobile terminal with a digital camera via a communication network. The display unit according to the present embodiment may include a display on a mobile terminal and a display provided on the back of a digital camera.

The above-described embodiment leads to the following invention.

One aspect of the present invention provides an image-capturing assistance device that includes: a target-conditions obtaining unit that obtains target conditions; an image-capturing-conditions obtaining unit that obtains image-capturing conditions of a subject on an image-capturing unit; an assistance-information storage unit that stores assistance information in association with the image-capturing conditions for specific editing conditions that depend on the image-capturing conditions among editing conditions obtained by the target-conditions obtaining unit; an assistance-information obtaining unit that reads out the assistance information corresponding to the specific editing conditions from the assistance-information storage unit on the basis of the image-capturing conditions; and a display unit that presents the assistance information obtained by the assistance-information obtaining unit.

According to this aspect, target conditions, which are editing conditions for a target image, are obtained by the target-conditions obtaining unit, and image-capturing conditions of a subject on an image-capturing unit are obtained by the image-capturing-conditions obtaining unit. In the case where there are specific editing conditions among the editing conditions obtained by the target-conditions obtaining unit, assistance information is read out from the assistance-information storage unit by the assistance-information obtaining unit, and displayed on the display unit.

The user performs actions in accordance with the assistance information displayed on the display unit, and as a result, an image can be obtained that reproduces a target image obtained in the past by adjusting the image-capturing conditions in a pseudo manner, even in a situation where the image-capturing conditions cannot be made the same in the image-capturing unit.

Another aspect of the present invention provides an image-capturing device that includes: an image-capturing unit that obtains an image by photographing a subject; the above-described image-capturing assistance device; and an editing unit that edits the image obtained by the image-capturing unit using common editing conditions, which do not depend on the image-capturing conditions, among editing conditions obtained by the target-conditions obtaining unit. The display unit presents the assistance information and the image edited by the editing unit.

According to this aspect, an image of a subject obtained by the image-capturing unit is edited by the editing unit using common editing conditions, which do not depend on image-capturing conditions, among editing conditions obtained by the target-conditions obtaining unit, and the edited image is displayed on the display unit along with assistance information.

In the above-described aspect, the image-capturing device may further include an image-storing unit that stores a plurality of images obtained by the image-capturing unit and edited using a plurality of editing conditions, in association with the editing conditions, and the target-conditions obtaining unit may use any of the images stored in the image-storing unit as the target image, and obtain the editing conditions therefor.

With this configuration, images obtained in the past by the image-capturing unit are stored in the image-storing unit, and a reproduced image can be obtained by using an image obtained in the past as a target by obtaining editing conditions of a target image using the target-conditions obtaining unit as specified by the user.

Furthermore, in the above-described aspect, the target-conditions obtaining unit may read editing conditions from an external storage unit that stores a plurality of images that have been edited using a plurality of editing conditions, in association with the editing conditions.

With this configuration, a reproduced image can be obtained by using an image obtained from another image-storing unit as a target image and reproducing the image using editing conditions read from an external storage unit.

Another aspect of the present invention provides an image-capturing assistance method that includes: obtaining target conditions including editing conditions for a target images; obtaining image-capturing conditions in which a subject is captured to obtain an image; storing assistance information in association with the image-capturing conditions for specific editing conditions that depend on the image-capturing conditions among editing conditions for editing the obtained image; reading out the assistance information corresponding to the specific editing conditions on the basis of the image-capturing conditions; and presenting the assistance information which is read out.

Another aspect of the present invention provides an image-capturing system that includes: an image sensor configured to obtain an image by photographing a subject; a storage; and at least one processor comprising hardware. The processor is configured to: obtain target conditions including editing conditions for a target images; obtain image-capturing conditions of the subject captured by the image sensor; allow the storage to store assistance information in association with the image-capturing conditions for specific editing conditions that depend on the image-capturing conditions among editing conditions for editing the image obtained by the image sensor; read out the assistance information corresponding to the specific editing conditions from the storage on the basis of the image-capturing conditions; edit the image obtained by the image sensor using common editing conditions, which do not depend on the image-capturing conditions, among the editing conditions for editing the image obtained by the image sensor; and allow a display to present the assistance information read out from the storage and the edited image.

Another aspect of the present invention provides an image-capturing assistance device that includes a processor comprising hardware. The processor is configured to generate assistance information for assisting a user when photographing a subject on the basis of target conditions including editing conditions for a target images, image-capturing conditions of the subject captured by an image sensor, and specific editing conditions that depend on the image-capturing conditions among editing conditions for editing the image obtained by the image sensor. The assistance information is in association with the image-capturing conditions.

### REFERENCE SIGNS LIST

1 image-capturing device
2 image-capturing unit
5 image-capturing assistance device
12 editing unit
13 image-storing unit
15 target-conditions obtaining unit
18 second-image-capturing-conditions obtaining unit (image-capturing-conditions obtaining unit)
19 assistance-information storage unit
20 assistance-information obtaining unit
21 display unit
22 external storage unit

1. An image-capturing assistance device comprising:
a storage; and
a processor comprising hardware, the processor configured to:
obtain target conditions including editing conditions for a target images;
obtain image-capturing conditions of a subject captured by an image sensor;
obtain editing conditions for editing the image obtained by the image sensor;
allow the storage to store assistance information in association with the image-capturing conditions for specific editing conditions that depend on the image-capturing conditions among the editing conditions;
read out the assistance information corresponding to the specific editing conditions from the storage on the basis of the image-capturing conditions; and
allow a display to present the assistance information read out from the storage.

2. An image-capturing device comprising:
an image sensor configured to obtain an image by photographing a subject; and
the image-capturing assistance device according to claim 1, wherein
the processor is configured to:
edit the image obtained by the image sensor using common editing conditions, which do not depend on the image-capturing conditions, among the editing conditions for editing the image obtained by the image sensor; and
allow a display to present the assistance information and the edited image.

3. The image-capturing device according to claim 2, wherein the processor is configured to:
allow the storage to store a plurality of images obtained by the image sensor and edited using a plurality of editing conditions, in association with the editing conditions; and
use any of the images stored in the storage as the target image, and obtain the editing conditions therefor.

4. The image-capturing device according to claim 2, wherein the processor is configured to read editing conditions from an external storage that stores a plurality of images that have been edited using a plurality of editing conditions, in association with the editing conditions.

5. An image-capturing assistance method comprising:
obtaining target conditions including editing conditions for a target images;
obtaining image-capturing conditions in which a subject is captured to obtain an image;
storing assistance information in association with the image-capturing conditions for specific editing conditions that depend on the image-capturing conditions among editing conditions for editing the obtained image;
reading out the assistance information corresponding to the specific editing conditions on the basis of the image-capturing conditions; and
presenting the assistance information which is read out.

6. An image-capturing system comprising:
an image sensor configured to obtain an image by photographing a subject;
a storage; and
at least one processor comprising hardware, the processor configured to:
obtain target conditions including editing conditions for a target images;
obtain image-capturing conditions of the subject captured by the image sensor;
allow the storage to store assistance information in association with the image-capturing conditions for specific editing conditions that depend on the image-capturing conditions among editing conditions for editing the image obtained by the image sensor;
read out the assistance information corresponding to the specific editing conditions from the storage on the basis of the image-capturing conditions;
edit the image obtained by the image sensor using common editing conditions, which do not depend on the image-capturing conditions, among the editing conditions for editing the image obtained by the image sensor; and
allow a display to present the assistance information read out from the storage and the edited image.

7. An image-capturing assistance device comprising:
a processor comprising hardware, the processor configured to generate assistance information for assisting a user when photographing a subject on the basis of target conditions including editing conditions for a target images, image-capturing conditions of the subject captured by an image sensor, and specific editing conditions that depend on the image-capturing conditions among editing conditions for editing the image obtained by the image sensor, the assistance information being in association with the image-capturing conditions.

8. An image-capturing assistance device comprising:
a processor comprising hardware, the processor configured to:
obtain target conditions including editing conditions for a target images, image-capturing conditions of a subject captured by an image sensor, and editing conditions for editing the image obtained by the image sensor;
generate assistance information in association with the image-capturing conditions for specific editing conditions that depend on the image-capturing conditions among the editing conditions for editing the image obtained by the image sensor; and
transmit the assistance information to outside of the processor.
